(19) United States
(12) Patent Application Publication
(10) Pub. No.: US 2021/0216262 A1
(43) Pub. Date: Jul. 15, 2021

(54) DISPLAY OF IMAGE DATA OF REMOTE DESKTOP ON MOBILE DEVICE

(71) Applicant: VMware, Inc., Palo Alto, CA (US)

(72) Inventors: Lin Lv, Beijing (CN); Tian Liu, Beijing (CN); Qian Liu, Beijing (CN); Yunxia Cheng, Beijing (CN); Jian Song, Beijing (CN)

(21) Appl. No.: 16/740,983

(22) Filed: Jan. 13, 2020

(51) Int. Cl. G06F 3/14; H04L 29/06; G06F 3/01; G06T 3/40; G06F 3/0485; G06F 9/451

(52) U.S. Cl. CPC G06F 3/14; H04L 65/4015; G06F 9/452; G06T 3/40; G06F 3/0485; G06F 3/017

(57) ABSTRACT

A method of displaying on a mobile computing device, an image from a remote computing device, includes the steps of receiving image data from the remote computing device, storing the image data in a memory of the mobile device, displaying a first image on the mobile device using a first portion of the stored image data, detecting a movement of the mobile device, and displaying a second image on the mobile device using a second portion of the stored image data upon detecting the movement. The second image is different from the first image.

### BACKGROUND

Currently, when a user connects to a remote desktop using a mobile device, such as from a smart phone, the image of the remote desktop will autofit to the mobile device's screen size. Because the screen size of the mobile device in pixels is generally much smaller than the size of an image of the remote desktop in pixels, the remote desktop will be displayed only partially on the mobile device. As a result, the user may have to keep tapping or swiping on the display of the mobile device to navigate to the desired portion of the remote desktop. If the user zooms out so that a greater portion of the remote desktop is displayed on the mobile device, the display resolution may become too poor to carry out editing, e.g., on presentation files or drawing files. As such, current user experience when accessing remote desktops from mobile devices is less than optimal and relatively unpleasant compared to when the access is from desktops with larger display sizes.

### SUMMARY

A method of displaying on a mobile computing device, an image from a remote computing device, according to one or more embodiments, includes the steps of receiving image data from a remote computing device, storing the image data in a memory of the mobile device, displaying a first image on the mobile device using a first portion of the stored image data, detecting a movement of the mobile device, and displaying a second image on the mobile device using a second portion of the stored image data upon detecting the movement. The first image is different from the first image.

Further embodiments of the present invention include a non-transitory computer readable storage medium that includes instructions that enable a processing unit to implement one or more aspects of the above method, as well as a remote desktop system configured to implement one or more aspects of the above method.

### BRIEF DESCRIPTION OF THE DRAWINGS

FIG. 1 illustrates components of a virtualized desktop infrastructure system in which one or more embodiments may be implemented.

FIG. 2 is a conceptual diagram that illustrates communication paths between remote desktop clients and agents when accessed from different types of client devices.

FIG. 3A is a sample image of a remote desktop generated by a virtual machine (VM) hosting the remote desktop.

FIG. 3B is a sample image of the remote desktop when displayed at a desktop computer.

FIGS. 3C-3D are sample images of the remote desktop when displayed at a mobile device.

FIGS. 4A and 4B are diagrams that illustrate a portion of the image of the remote desktop that is displayed on a mobile device and how the displayed portion changes as the mobile device is moved.

FIG. 5 is a flow diagram showing steps carried out to generate an image of the remote desktop initially and update the image of the remote desktop as the mobile device is moved, according to one or more embodiments.

FIG. 6 is a diagram showing an image of the remote desktop, and portions of the image that may be provided to the mobile device.

### DETAILED DESCRIPTION

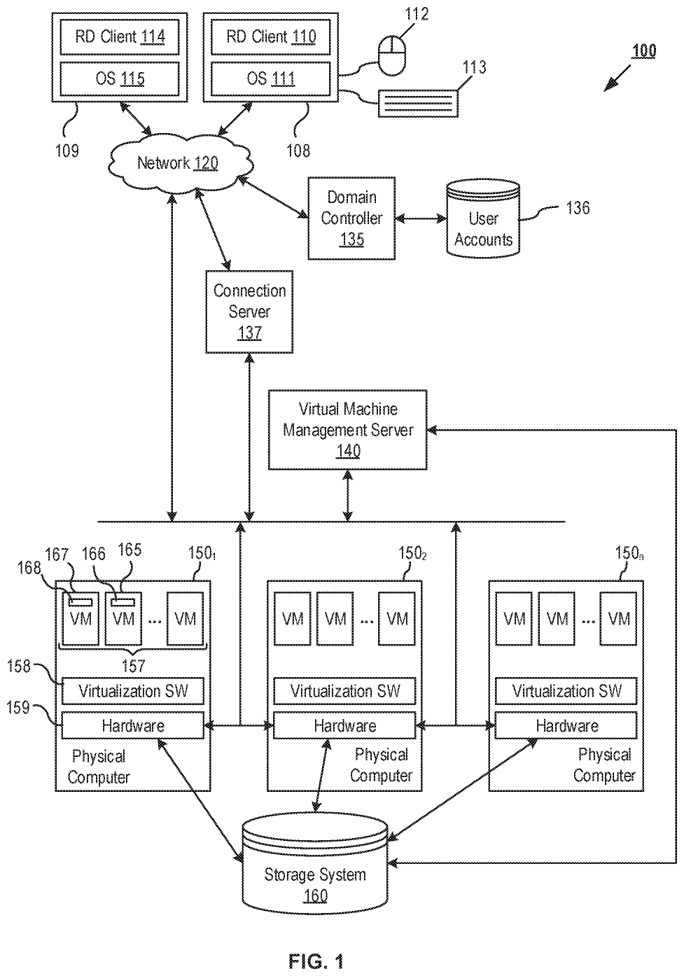

FIG. 1 illustrates components of a virtualized desktop infrastructure (VDI) system (also referred to as a remote desktop computer system) in which one or more embodiments may be implemented. In VDI system 100, remote desktop client software programs (also referred to as “RD clients” for short) run on operating systems of local computing devices. In the embodiment illustrated in FIG. 1, RD client 110 runs on top of operating system (OS) 111 of client device 108 that corresponds to a desktop personal computer, and RD client 114 runs on top of OS 115 of client device 109 that corresponds to a mobile device such as a smart phone. In addition, client device 108 has attached thereto a set of input devices including a mouse 112 and a keyboard 113, and client device 109 employs a touchscreen as an input device (e.g., the touchscreen on a smart phone).

RD clients provide an interface for the users to access their desktops, which may be running in one of virtual machines 157 or blade server (not shown) in a data center that is remote from the user locations. The term, “desktop” refers to the instance of an interactive operating environment provided by a computer operating system and software applications, typically in the form of a display and sound output and keyboard and mouse input. With RD clients, users can access desktops running in a remote data center through network 120, from any location, using a general purpose computer running a commodity operating system and a RD client software program such as VMware® View™, or a special purpose thin client such as those available from Dell, HP, NEC, Sun Microsystems, Wyse, and others.

VDI system 100 includes a domain controller 135, such as Microsoft® Active Directory®, that manages user accounts 136 including user log-in information, and a connection server 137 that manages connections between RD clients and desktops running in virtual machines 157 or other platforms. Domain controller 135 and connection server 137 may run on separate servers or in separate virtual machines running on the same server or different servers. In the embodiments illustrated herein, desktops are running in virtual machines (VMs) 157 and VMs 157 are instantiated on a plurality of physical computers 150₁, 150₂, . . . , 150ₙ. VMs 157 include VM 165 which includes an RD agent 166, and VM 167 which includes an RD agent 168. Each of the physical computers 150₁, 150₂, . . . , 150ₙ includes virtualization software 158 and hardware 159, and each of the physical computers 150₁, 150₂, . . . , 150ₙ is controlled by a virtual machine management server 140, and is coupled to a shared persistent storage system 160.

A particular configuration of the virtualized desktop infrastructure is described above and illustrated in FIG. 1, but it should be recognized that one or more embodiments may be practiced with other configurations of the virtualized desktop infrastructure.

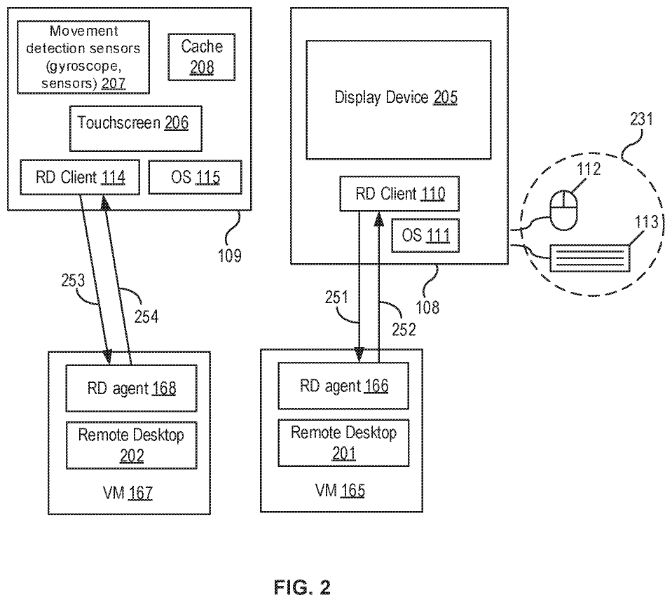

In more detail, and with reference also to FIG. 2, a remote desktop hosted by VM 165 is launched by client device 108 through RD client 110, and a remote desktop hosted by VM 167 is launched by client device 109 through RD client 114.

When the remote desktop hosted by VM 165 is launched, RD client 110 and RD agent 166 establish a communication channel through which user inputs made via mouse 112 and keyboard 113 of client device 108 are transmitted to RD agent 166 and a communication channel 252 through which an image of remote desktop 201 generated in VM 165 is transmitted to client device 108, which displays the image of remote desktop 201 on a display device 205 of client device 108, e.g., a computer monitor having a sufficiently large screen size (in pixels) to fully display the image of remote desktop 201.

When the remote desktop hosted by VM 167 is launched, RD client 114 and RD agent 168 establish a communication channel through which user inputs made via the touchscreen of client device 109 are transmitted to RD agent 168 and a communication channel through which an image of remote desktop 202 generated in VM 167 is transmitted to client device 109. Client device 109 displays the image of remote desktop 202 on a touchscreen 206 of client device 109, e.g., a touchscreen having a display size (in pixels) that is too small to fully display the image of remote desktop 202.

As used herein, the maximum number of pixels that can be displayed within a particular display or a window, usually expressed as Hmax by Vmax (where Hmax is the maximum number of pixels in the horizontal direction and Vmax is the maximum number of pixels in the vertical direction), is referred to as its display size or its window size, respectively. For comparison purposes, a size of an image is also expressed herein as X pixels by Y pixels, and is considered larger than a display size or a window size if either X>Hmax of the display or window or Y>Vmax of the display or window.

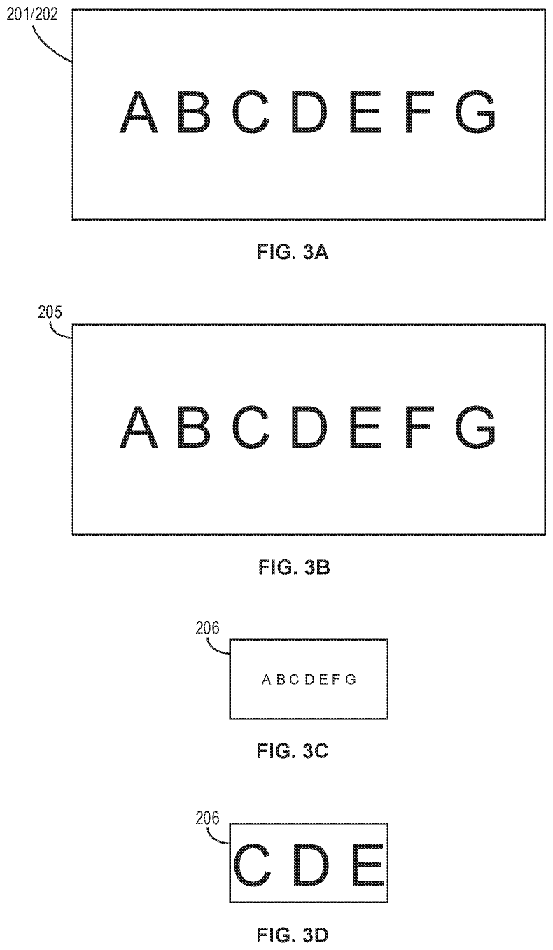

FIG. 3A is a sample image of a remote desktop 201/202 generated by VM 165 and VM 167. The image includes the letters “A B C D E F G” in large font (e.g., 48-point font). This image, when displayed on display device 205 of client device 108 (which we assumed above is capable of fully displaying the image of remote desktop 201), will be displayed in the same large font (e.g., 48-point font) as in the image of the remote desktop. This is illustrated in FIG. 3B.

However, when this image is displayed on client device 109 (i.e., on touchscreen 206) the image is reduced to a smaller font, e.g., 10-point font, so that it can fit entirely within touchscreen 206 (see FIG. 3C). In this example, it is assumed that the size of the image of the remote desktop is 7680 pixels by 4800 pixels and the display size of touchscreen 206 is 1920 pixels by 1200 pixels. As such, if the user desires to see the image in the same large font as in the original image, the user has to perform a zoom-out action via his/her fingers on the touchscreen 206 to increase the resolution (e.g., swipe first and second fingers outwards from a center position of the display screen). However, when the user does this, only a portion of the “A B C D E F G” image is shown in the desired 48-point font, as shown in FIG. 3D. This forces the user to perform a left or right scroll operation via touchscreen 206 to see other portions of the image.

According to embodiments, even though the display size of touchscreen 206 of client device 109 is not large enough to display the image of remote desktop 202 entirely, the entire image or a large portion of the entire image (all of which cannot be displayed on touchscreen 206) is transmitted from VM 167 to client device 109, and client device 109 stores the entire image in cache 208. As movements of client device 109 are detected by movement detection sensors 207, e.g., accelerometers, gyroscopes, etc., client device 109 updates the portion of the image that is displayed on touchscreen 206 using the image stored in cache 208 in accordance with the detected movements. The movements that are detectable by movement detection sensors 207 include left, right, up, and down movements relative to the user, and also movements of client device 109 towards the user and movements of client device 109 away from the user.

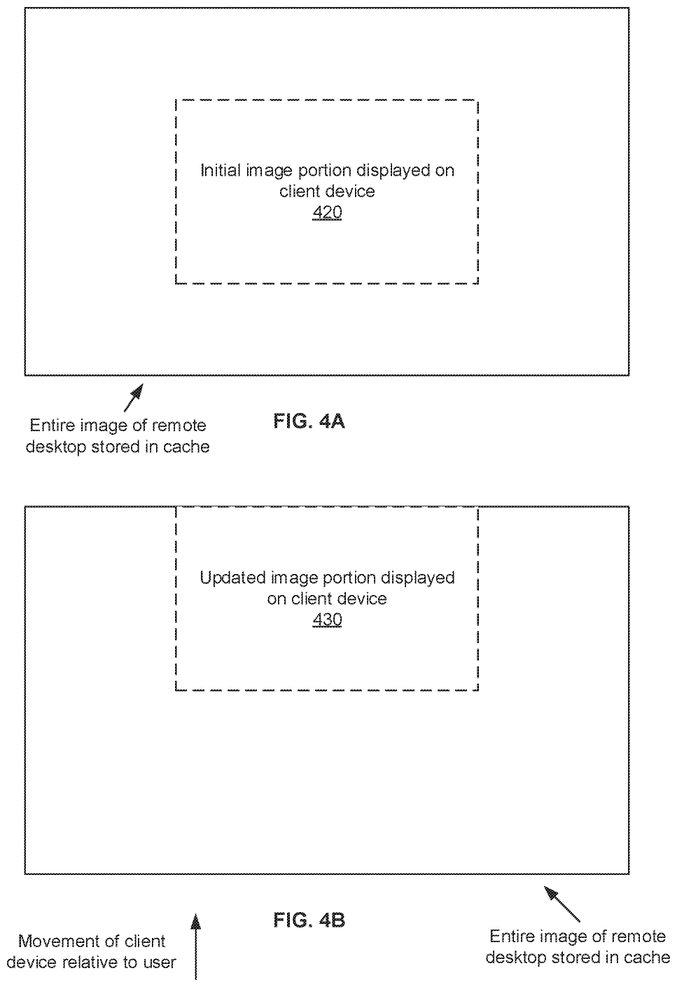

FIGS. 4A and 4B are diagrams that illustrate a portion of the image of the remote desktop that is displayed on a mobile device and how the displayed portion changes as the mobile device is moved. As described above, the entire image of remote desktop 202 (or a large portion thereof) is stored in cache 208 of client device 109 and is depicted as a solid-line box in FIG. 4A. However, only a portion 420, depicted as a dashed-line box in FIG. 4A, is displayed on touchscreen 206 because the size of the image stored in cache 208 is larger than the display size of touchscreen 206. When the user moves client 109 in an upward direction, movement detection sensors 207 detect such movement and client device 109 updates the portion of the image that is displayed on touchscreen 206 using the image stored in cache 208. The updated image portion is depicted as 430 in FIG. 4B. As will be further described below, the image stored in cache 208 may also be updated (e.g., when less than the entire image of the remote desktop is stored in cache 208); however, updated image portion 430 can be displayed using the current image stored in cache 208 and without waiting for the cache 208 to be refreshed with the new image. In this manner, display latency can be minimized.

In a similar manner, if the user wants to see the portion of the image of remote desktop 202 that is below, to the left, or to the right of portion 420, the user merely has to move client device 109 in a downward, left, or right direction. In response, movement detection sensors 207 detect such movement and client device 109 updates the portion of the image that is displayed on touchscreen 206 using the image stored in cache 208.

The movement of client device 109 towards the user (also referred to herein as a forward direction) and away from the user (also referred to herein as a backward direction) changes the resolution of the image that is currently displayed on touchscreen 206 and thus updates the image displayed on touchscreen 206 after the image stored in cache 208 is entirely updated. When the user moves client device 109 in the backward direction and movement detection sensors 207 detect such a movement, client device 109 in response will request a new image of remote desktop 202 of an increased resolution from RD agent 168 of VM 167 and display it upon receipt. Similarly, when the user moves client device 109 in the forward direction and movement detection sensors 207 detect such a movement, client device 109 in response will request a new image of remote desktop 202 of a decreased resolution from RD agent 168 of VM 167 and display it upon receipt. To avoid triggering the remote resolution scaling unnecessarily, in one or more embodiments, a user has to perform another action while moving client device 109 in the forward or backward direction, such as keeping his/her thumb pressed on touchscreen 206 while the user moves client device 109 in the forward or backward direction.

In one embodiment, a camera may be used as a movement detection sensor. Using an image captured from the camera, a size of a user's body part (e.g., face) may be continually measured and from the changes in the size of the user's body part and determine whether the movement direction is toward the user (forward) or away from the user (backward).

In another embodiment, a temperature sensor may be used as a movement detection sensor. The temperature sensor may be continually monitoring an ambient temperature around the vicinity of client device 109. If client device 109 is moved toward the user, the measured temperature is expected to increase and if client device 109 is moved away from the user, the measured temperature is expected to decrease.

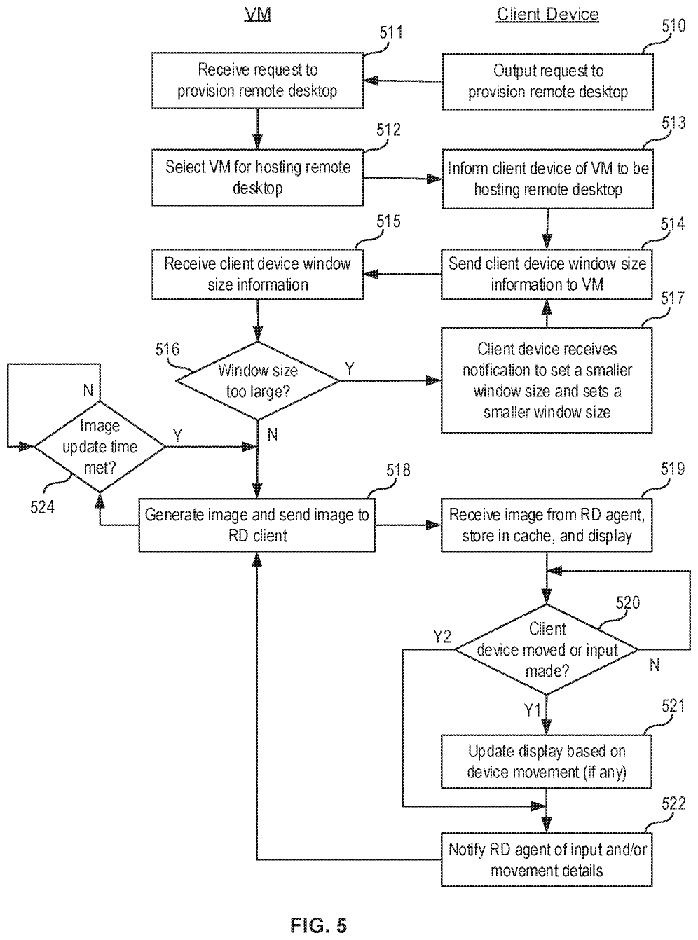

FIG. 5 is a flow diagram showing steps carried out to generate an image of the remote desktop initially and update the image of the remote desktop as the mobile device is moved, according to one or more embodiments.

Steps 510-513 represent conventional steps for provisioning a remote desktop in a VM in response to a user request, e.g., when the user logs into his or her account in VDI 100. At step 513, client device 109 sets a window size for the remote desktop. Conventionally, a user is not allowed to set a window size for the remote desktop that is larger than the display size of client device 109. However, in this embodiment, the user is permitted to set any window size. For example, the user can set the window size to be 7680×4800 pixels, which is in general about four (4) times larger than the maximum size than what conventional mobile devices can display. In this embodiment, however, the window size that the user can set has a maximum allowable value, such as no more than 10 times the display size of client device 109, so as to prevent too much memory from being consumed by client device 109. Thus, upon receiving at step 515 the window size set at step 514 by the user, the VM at step 516 determines if the window size is too large. If so, the VM notifies client device 109 to set a smaller window size. Upon receiving the notification at step 517, client device 109 resets the window size to a smaller size and executes step 514 again to send the newly set window size to the VM.

If at step 516, the VM determines that the window size is not too large, the VM at step 518 generates the image of the remote desktop to have the window size set by the user and sends the image to client device 109. Upon receipt of the image of the remote desktop at step 519, client device 109 stores the image in cache 208 and displays a portion of the image on touchscreen 206 (e.g., portion 420 depicted in FIG. 4A).

Then, at step 520, client device 109 waits for a movement event (as detected by movement detection sensors 207) or an input event (e.g., a user input made on touchscreen 206). Upon detecting a movement event that is triggered by an upward, downward, left, or right movement of client device 109, client device 109 proceeds along the Y1 branch to update the display using the image stored in cache 208 at step 521. Then, client device 109 step 522 notifies the VM of the detected movement. Upon detecting an input event or a movement of client device 109 that is triggered by forward or backward movement of client device 109, client device 109 proceeds along the Y2 branch to skip step 521 and notify the VM of the detected movement or the detected input at step 522.

In response to the notification from client device 109, the VM at step 518, generates an updated image and sends the updated image to client device 109. The VM generates the updated image in accordance with the input and/or movement details. For example, if the user selected an application to launch on touchscreen 206, the VM launches the application on the remote desktop and updates the image of the remote desktop to show a window of the launched application on the remote desktop. Also, if the movement details indicate that the user moved client device 109 upward, downward, left, or right, the VM generates a new image of the remote desktop if there are portions of the remote desktop that are not captured in the current image. For example, if only the top half of the remote desktop is captured in the current image and the detected movement is downward, the VM generates a new image of the remote desktop to show more of the bottom half of the remote desktop and less of the top half of the remote desktop depending on the magnitude of the detected movement. Further, if the movement details indicate that the user moved client device 109 in the forward or backward direction, the VM generates a new image of the remote desktop to have an increased resolution (in response to client device 109 being moved away from the user) and to have a decreased resolution (in response to client device 109 being moved towards the user).

In addition, the VM monitors a time period (e.g., image update every 5 seconds, every 10 seconds, etc.) for updating the image of the remote desktop. Upon expiration of each such time period as determined at step 524, the VM executes step 518 again to generate a new image of the remote desktop and sends the new image to client device 109.

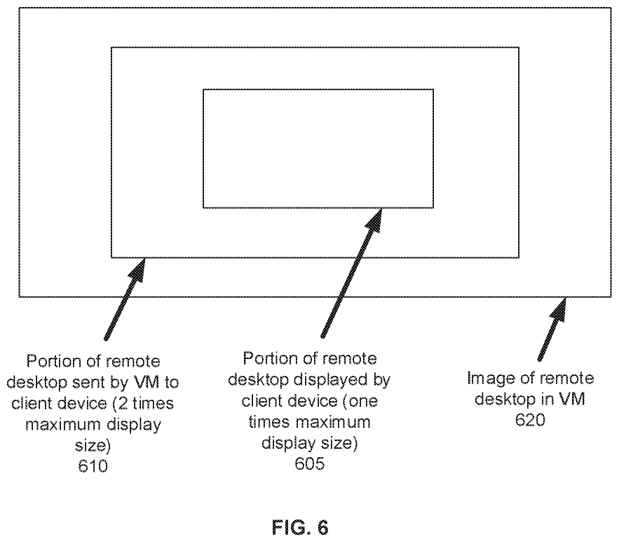

In the embodiments described above, the window size set by the user at step 514 is accepted by the VM so long as the window size is too large. In an alternative embodiment, which is conceptually illustrated in FIG. 6, the VM sets the window size automatically to be a size somewhere between the maximum size that can be displayed by client device 109 (which is depicted as 605 in FIG. 6) and the size of the image of the remote desktop (which is depicted as 620 in FIG. 6). The intermediate size set by the VM is depicted as 610 in FIG. 6. For example, if the maximum window size that can be displayed by client device 109 is X by Y and the size of the image of the remote desktop is 2X by 2Y, the VM sets the window size to be, e.g., 1.5X by 1.5Y, 2X by Y, or X by 2Y. The alternative embodiment of FIG. 6 may be applied to a remote desktop having a window in which a video is replayed. In such cases, the image of the remote desktop is continually updated and the transmission bandwidth between the VM and client device 109 is conserved by setting the window size to be of an intermediate size.

Embodiments have been described above using the example of two client devices 108, 109. However, client device 108 is included only for illustrative purposes and embodiments can be practiced with only client device 109 or with client device 109 in combination with other types of client devices. In addition, one example of client device 109 is given as a smart phone. Another example of client device 109 is a tablet computer. Also, remote desktops are given as examples herein but embodiments are applicable to remote applications and to a combination of one or more remote desktops and one or more remote applications.

In the embodiments described above, the display of client device 109 is changed when a user moves client device 109 upwards, downwards, left or right. In an alternative embodiment, the display of client device 109 is only changed when client device 109 is moved upwards, downwards, left or right, while the user performs a predetermined operation on touchscreen 206, such as keeping the user's thumb pressed on touchscreen 206. Also, client device 109 may include configuration settings that allows the user to designate the relationship between the amount of movement and the amount of shift in the display, e.g., a one-inch move upwards, downwards, left or right from a current position of the mobile devices causes a 10% shift in what is currently being displayed in that direction.

As used herein, a “connection server” is any apparatus that is configured to manage connections to remote user sessions such as remote desktops and is also referred to as a “connection broker,” and a “domain controller” is any apparatus that is configured to have access to and manage user log-in information.

Certain embodiments as described above involve a hardware abstraction layer on top of a host computer. The hardware abstraction layer allows multiple contexts or virtual computing instances to share the hardware resource. In one embodiment, these virtual computing instances are isolated from each other, each having at least a user application running therein. The hardware abstraction layer thus provides benefits of resource isolation and allocation among the virtual computing instances. In the foregoing embodiments, virtual machines are used as an example for the virtual computing instances and hypervisors as an example for the hardware abstraction layer. As described above, each virtual machine includes a guest operating system in which at least one application runs. It should be noted that these embodiments may also apply to other examples of virtual computing instances, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

In addition, while described virtualization methods have generally assumed that virtual machines present interfaces consistent with a particular hardware system, persons of ordinary skill in the art will recognize that the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. Further, the virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

1. A method of displaying images on a mobile computing device from a remote computing device, the method comprising:
receiving, at the mobile device, image data from the remote computing device, the image data including an image having a resolution larger than a maximum resolution that can be displayed on a display of the mobile device;
storing the image data in a memory of the mobile device;
displaying a first image on the display of the mobile device using a first portion of the stored image data, a resolution of the first image being at most the maximum resolution;
detecting a movement of the mobile device; and
upon detecting the movement, displaying a second image on the mobile device using a second portion of the stored image data, a resolution of the second image being at most the maximum resolution, wherein the second image is different from the first image.

2. The method of claim 1, wherein, within the image, the second image is positioned relative to the first image in a same direction as a direction of the detected movement.

3. The method of claim 2, wherein the detected movement is in an upward, downward, left, or right direction.

4. The method of claim 1, further comprising:
receiving at the mobile device the resolution of the image as selected by the user; and
prior to receiving the image data from the remote computing device, transmitting to the remote computing device, the resolution of the image.

5. The method of claim 4, wherein the resolution of the image is equal to a resolution of a remote desktop rendered by the remote computing device.

6. The method of claim 4, wherein the resolution of the image is less than a resolution of a remote desktop rendered by the remote computing device.

7. The method of claim 6, further comprising:
upon detecting the movement, transmitting to the remote computing device a request for updated image data; and
upon receipt of the updated image data, storing the updated image data in the memory of the mobile device.

8. A method of displaying on a mobile computing device, an image from a remote computing device, the method comprising:
receiving, at the mobile device, image data from the remote computing device, the image data including an image having a resolution larger than a maximum resolution that can be displayed on a display of the mobile device;
storing the image data in a memory of the mobile device;
displaying a first image on the display of the mobile device using a first portion of the stored image data, a resolution of the first image being at most the maximum resolution;
detecting a movement of the mobile device;
upon detecting the movement, transmitting to the remote computing device a request for updated image data;
upon receipt of the updated image data from the remote computing device, storing the updated image data in the memory of the mobile device and displaying a second image on the mobile device using the stored updated image data, wherein the first image and the second image have different resolutions.

9. The method of claim 8, wherein the detected movement is a movement of the mobile device towards a body of a user of the mobile device, and the second image has a lower resolution than the first image.

10. The method of claim 8, wherein the detected movement is a movement of the mobile device away from a body of a user of the mobile device, and the second image has a higher resolution than the first image.

11. The method of claim 8, further comprising:
receiving at the mobile device the resolution of the image as selected by the user; and
prior to receiving the image data from the remote computing device, transmitting to the remote computing device, the resolution of the image.

12. The method of claim 11, wherein the resolution of the image is equal to a resolution of a remote desktop rendered by the remote computing device.

13. The method of claim 11, wherein the resolution of the image is less than a resolution of a remote desktop rendered by the remote computing device.

14. A non-transitory computer readable medium comprising instructions that are executable in a mobile computing device, wherein the instructions when executed in the mobile computing device cause the mobile computing device to carry out a method comprising the steps of:
receiving, at the mobile device, image data from a remote computing device, the image data including an image having a resolution larger than a maximum resolution that can be displayed on a display of the mobile device;
storing the image data in a memory of the mobile device;
displaying a first image on the display of the mobile device using a first portion of the stored image data, a resolution of the first image being at most the maximum resolution;
detecting a movement of the mobile device;
upon detecting the movement that is of a first type, displaying a second image on the mobile device using a second portion of the stored image data, a resolution of the second image being at most the maximum resolution, wherein the second image is different from the first image; and
upon detecting the movement that is of a second type, transmitting to the remote computing device a request for updated image data, storing the updated image data in the memory of the mobile device upon receipt of the updated image data from the remote computing device, and displaying a third image on the mobile device using the stored updated image data, wherein the first image and the third image have different resolutions.

15. The non-transitory computer readable medium of claim 14, wherein, within the image, the second image is positioned relative to the first image in a same direction as a direction of the detected movement of the first type.

16. The non-transitory computer readable medium of claim 15, wherein the detected movement of the first type is in an upward, downward, left, or right direction.

17. The non-transitory computer readable medium of claim 14, wherein the method further comprises:
upon detecting the movement of the first type, transmitting to the remote computing device a request for updated image data; and
upon receipt of the updated image data, storing the updated image data in the memory of the mobile device.

18. The non-transitory computer readable medium of claim 14, wherein the detected movement of the second type is a movement of the mobile device towards a body of a user of the mobile device, and the third image has a lower resolution than the first image.

19. The non-transitory computer readable medium of claim 14, wherein the detected movement of the second type is a movement of the mobile device away from a body of a user of the mobile device, and the third image has a higher resolution than the first image.

20. The non-transitory computer readable medium of claim 14, further comprising:
receiving at the mobile device the resolution of the image as selected by the user; and
prior to receiving the image data from the remote computing device, transmitting to the remote computing device, the resolution of the image.
